(19) United States
(12) Patent Application Publication
(10) Pub. No.: US 2016/0006667 A1
(43) Pub. Date: Jan. 7, 2016

(54) Anti-packet-loss real-time communication method, system and related device based on hierarchical coding

(71) Applicant: ZTE Corporation, Shenzhen, Guangdong (CN)

(72) Inventors: Ya Lin, Shenzhen (CN); Jiazhou Li, Shenzhen (CN); Yaping Ruan, Shenzhen (CN)

(21) Appl. No.: 14/769,626

(22) PCT Filed: Aug. 23, 2013
(86) PCT No.: PCT/CN2013/082203

§ 371 Date: Aug. 21, 2015

(30) Foreign Application Priority Data
Feb. 22, 2013 (CN) 201310057423.2

(51) Int. Cl. H04L 12/927; H04L 29/08; H04L 12/26

(52) U.S. Cl. CPC H04L 47/805; H04L 43/0829; H04L 43/087; H04L 43/0858; H04L 69/324

(57) ABSTRACT

Disclosed are an anti-packet-loss real-time communication method, system and related device based on hierarchical coding. A transmitting end initially sets a coding parameter and a packaging parameter according to a network condition difference, and generates a payload containing coded data and protected data simultaneously according to the coding parameter and the packaging parameter and transmits the payload to a receiving end; the receiving end counts network status parameters according to the received payload and transmits the network status parameters to the transmitting end; and the transmitting end adjusts the coding parameter and the packaging parameter in real time according to the network status parameters, and generates a payload containing coded data and protected data simultaneously according to the adjusted coding parameter and packaging parameter. The present disclosure performs self-adaptive processing on packet loss or congestion occurring in a network during real-time communication, i.e., adjusts the code rate and transmission position of protected data in real time according to network conditions, thereby effectively preventing voice discontinuousness, image mess or pause occurring at a client, and improving the user experience.

### TECHNICAL FIELD

The present disclosure relates to the technical field of communications, and in particular to an anti-packet-loss real-time communication method, system and related device based on hierarchical coding.

### BACKGROUND

In the real-time communication, audio and video media typically are transmitted using a user datagram protocol. Since the user packet protocol is a connectionless transmission protocol, which cannot provide reliable transmission service, packet loss inevitably occurs in network, thus results in voice discontinuousness, image mess, pause or other phenomenon, thereby degrading the quality of calls seriously.

The reason of packet loss may be generally classified into random packet loss and congestion packet loss. Currently, methods for anti-packet loss may generally include interleaving and retransmission. However, the transmission code rate and the transmission location cannot be adjusted in real time according to network conditions in these methods, therefore, the anti-packet-loss performance is poor and is needed to be further improved.

### SUMMARY

In view of the above analysis, the present disclosure is intended to provide an anti-packet-loss real-time communication method, system and related device based on hierarchical coding in order to further improve the performance of anti-packet loss in network.

The object of the present disclosure is mainly achieved by the following technical solutions.

An embodiment of the present disclosure provides a method for anti-packet-loss real-time communication based on hierarchical coding. The method includes:

a transmitting end generates a payload containing coded data and protected data simultaneously according to coding parameters and packaging parameters which have been set, and transmits the payload to a receiving end;

the receiving end counts network status parameters according to the received payload and transmits the network status parameters to the transmitting end; and

the transmitting end adjusts the coding parameters and the packaging parameters in real time according to the network status parameters, and generates a payload containing coded data and protected data simultaneously according to the adjusted coding parameters and packaging parameters.

Preferably, the method may include:

the transmitting end determines whether a coded packet is lost according to the received payload, and when determining that the coded packet is lost, the transmitting end finds protected data corresponding to the lost coded packet according to indication information in the received payload, and recovers the lost coded packet.

Preferably, the network status parameters may include one or more of a packet loss rate, a continuous packet loss rate, delay, jitter or a target code rate.

Preferably, the step that the transmitting end adjusts the coding parameters and the packaging parameters in real time according to the network status parameters may include:

the transmitting end sets the target code rate according to the network status parameters and adjusts the coding parameters and the packaging parameters in real time according to the target code rate and the packet loss rate.

Preferably, the step of adjusting the coding parameters and the packaging parameters in real time according to the target code rate and the packet loss rate may include:

when the packet loss rate is lower than or equal to a preset packet loss rate threshold, a code rate of the coded data is set only according to the target code rate without addition of protected data; when the packet loss rate is greater than the preset packet loss rate threshold, a code rate of the protected data is increased within the limits of the target code rate, wherein the coding parameters may include the code rate of the coded data and the packaging parameters may include the code rate of the protected data.

Preferably, the method may further include:

part of or entire stream is captured from coded data corresponding to a transmission position of the protected data according to the adjusted packaging parameters and is taken as protected data; when the continuous packet loss rate is lower than a preset continuous packet loss rate threshold, the transmission position of the protected data is placed in a next frame; and when the continuous packet loss rate is greater than the preset continuous packet loss rate threshold, the transmission position of the protected data is placed in a frame after the next frame, while indication information about the transmission position is added into the payload.

An embodiment of the present disclosure further provides a system for anti-packet-loss real-time communication based on hierarchical coding. The system includes a transmitting end and a receiving end;

the transmitting end may be configured to generate a payload containing coded data and packaged data simultaneously according to coding parameters and packaging parameters which have been set and transmit the payload to the receiving end; and adjust the coding parameters and packaging parameters in real time according to network status parameters transmitted by the receiving end, and generate a payload containing coded data and protected data simultaneously according to the adjusted coding parameters and packaging parameters; and

the receiving end may be configured to receive the payload transmitted by the transmitting end, and count the network status parameters according to the payload and transmit the network status parameters to the transmitting end.

Preferably, the receiving end may be further configured to determine whether a coded packet is lost according to the payload transmitted by the transmitting end, and when determining that the coded packet is lost, find protected data corresponding to the lost coded packet according to indication information in the payload, and recover the lost coded packet.

An embodiment of the present disclosure further provides a transmitting end. The transmitting end includes:

a setting unit configured to set coding parameters and packaging parameters according to a network condition difference and transmit the coding parameters and the packaging parameters to a coding unit;

the coding unit is configured to generate a payload containing coded data and protected data simultaneously according to the coding parameters and the packaging parameters transmitted by the setting unit or the coding parameters and packaging parameters adjusted and transmitted by a adjusting unit, and transmit the payload to a receiving end;

the adjusting unit is configured to adjust the coding parameters and the packaging parameters in real time according to the network status parameters transmitted by the receiving end, and transmit the adjusted coding parameters and packaging parameters to the coding unit.

Preferably, the adjusting unit may be specifically configured to set a target code rate according to the network status parameters transmitted by the receiving end; when a packet loss rate is lower than or equal to a preset packet loss rate threshold, set a code rate of the coded data only according to the target code rate without addition of protected data; when the packet loss rate is greater than the preset packet loss rate threshold, increase a code rate of the protected data within the limits of the target code rate, wherein the coding parameters may include the code rate of coded data and the packaging parameters may include the code rate of the protected data; further configured to capture part of or entire stream from coded data corresponding to a transmission position of the protected data according to the adjusted packaging parameters and take the part of or entire stream as protected data; and when a continuous packet loss rate is lower than a preset continuous packet loss rate threshold, place the transmission position of the protected data in a next frame; and when the continuous packet loss rate is greater than the preset continuous packet loss rate threshold, place the transmission position of the protected data in a frame after the next frame.

An embodiment of the present disclosure further provides a receiving end, includes:

a receiving unit configured to receive a payload containing coded data and protected data transmitted by a transmitting end; and

a counting unit configured to count network status parameters according to the payload received by the receiving unit and transmit the network status parameters to the transmitting end.

Preferably, the receiving end may further include a determining unit configured to determine whether a coded packet is lost according to the payload received by the receiving unit, and when determining that the coded packet is lost, find protected data corresponding to the lost coded packet according to indication information in the received payload, and recover the lost coded packet.

The embodiments of the present disclosure provide an anti-packet-loss real-time communication method, system and related device based on hierarchical coding. A receiving end counts the current network status parameters in real-time and transmits the network status parameters to a transmitting end. The transmitting end adjusts coding parameters and packaging parameters in real time according to the current network status parameter, and assigns a code rate of coded data and a code rate of protected data in the packaged payload according to the coding parameters and the packaging parameters. In other words, the embodiments of the present disclosure perform self-adaptive processing on packet loss or congestion occurring in a network during real-time communication, i.e., adjust the code rate and transmission position of protected data in real time according to network conditions, thereby effectively preventing voice discontinuousness, image mess or pause occurring at a client, and improving the user experience.

### BRIEF DESCRIPTION OF THE DRAWINGS

FIG. 1 is a flow chart of a method for anti-packet-loss real-time communication based on hierarchical coding in accordance with the Embodiment 1 of the present disclosure;

FIG. 2 is a schematic structure diagram of a packaged payload in accordance with the Embodiment 1 of the present disclosure;

FIG. 3 is a schematic structure diagram of a transmitting end in accordance with the Embodiment 3 of the present disclosure;

FIG. 4 is a schematic structure diagram of a receiving end in accordance with the Embodiment 4 of the present disclosure.

### DETAILED DESCRIPTION

The preferred embodiments of the present disclosure are described in further detail below in conjunction with the accompanying drawings. The accompanying drawings constitute a part of the present disclosure, and are used to explain the principles of the present disclosure together with the embodiments of the present disclosure. For the purpose of clarity and simplicity, when it may obscure the subject matter of the present disclosure, the detail description for the known functions and structures of devices described herein will be omitted.

### Embodiment 1

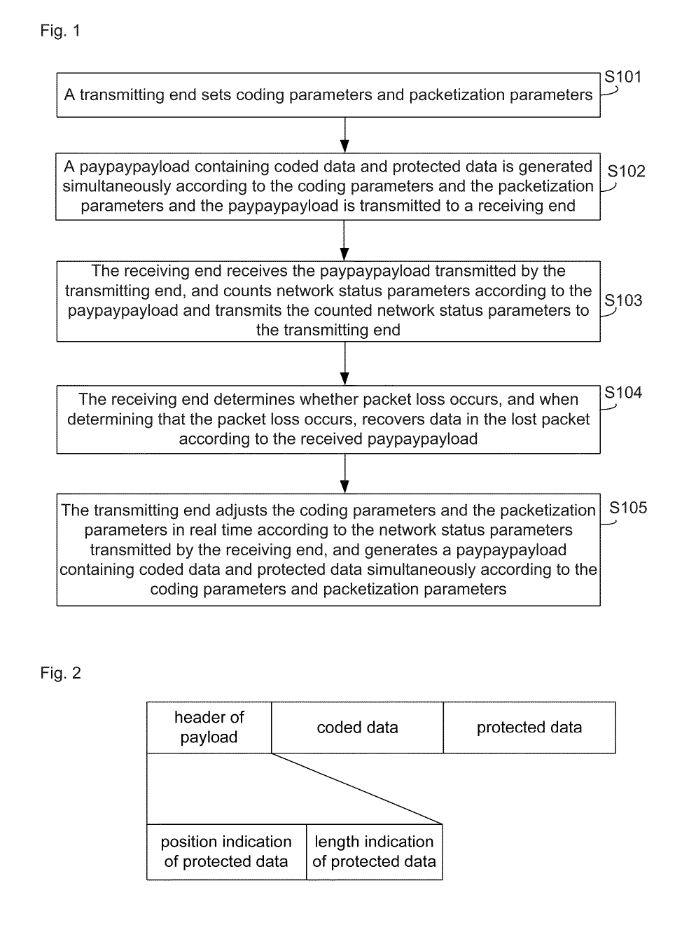

The embodiment of the present disclosure provides a method for anti-packet-loss real-time communication based on hierarchical coding. Referring to FIG. 1, the method includes:

S101: a transmitting end sets coding parameters and packaging parameters;

it should be noted that the transmitting end sets the coding parameters and the packaging parameters according to a scenario in which the network condition is poor; further, the poor network condition may include the presence of a continuous packet loss, a narrower available bandwidth, a high packet loss rate, etc.;

S102: a payload containing coded data and protected data is generated simultaneously according to the coding parameters and the packaging parameters and the payload is transmitted to a receiving end;

in the embodiment of the present disclosure, the protected data in the payload is part of or entire data in the coded data;

S103: the receiving end receives the payload transmitted by the transmitting end, and count network status parameters according to the payload, and transmits the counted network status parameters to the transmitting end;

in the embodiment of the present disclosure, the network status parameters may include one or more of following: a packet loss rate, delay, jitter, a target code rate or a continuous packet loss rate;

S104: the receiving end determines whether packet loss occurs, and when determining that packet loss occurs, the receiving end recovers data in the lost packet according to the received payload; and

S105: the transmitting end adjusts the coding parameters and the packaging parameters in real time according to the network status parameters transmitted by the receiving end, and generates a payload containing coded data and protected data simultaneously according to the coding parameters and packaging parameters.

This step may specifically include that: the transmitting end sets a target code rate according to the network status parameters transmitted by the receiving end and adjusts the coding parameters and the packaging parameters according to the target code rate and the packet loss rate; when the packet loss rate is lower than or equal to a preset packet loss rate threshold, the transmitting end sets a code rate of the coded data only according to the target code rate without addition of protected data; when the packet loss rate is greater than the preset packet loss rate threshold, the transmitting end increases a code rate of the protected data within the limits of the target code rate, wherein the coding parameters may include the code rate of the coded data and the packaging parameters may include the code rate of the protected data. FIG. 2 illustrates a structure diagram of a packaged payload in an embodiment of the present disclosure, which includes a header of the payload, coded data and protected data, wherein the header of the payload indicates the length of the protected data and the position of the protected data.

The method may further include: part of or entire stream is captured from coded data corresponding to the transmission position of the protected data according to the adjusted packaging parameters and the part of or entire stream is taken as protected data; when the continuous packet loss rate is lower than a preset continuous packet loss rate threshold, the transmission position of the protected data is placed in the next frame; and when the continuous packet loss rate is greater than the preset continuous packet loss rate threshold, the transmission position of the protected data is placed in the frame after the next frame, while indication information about the transmission position is added into the payload.

The embodiment of the present disclosure provides an anti-packet-loss real-time communication method based on hierarchical coding. The method includes that: a receiving end counts the current network status parameters in real-time and transmits the network status parameters to a transmitting end; the transmitting end adjusts coding parameters and packaging parameters in real time according to the current network status parameter, and assigns a code rate of coded data and a code rate of protected data in the packaged payload according to the coding parameters and the packaging parameters. The embodiment of the present disclosure performs self-adaptive processing on packet loss or congestion occurring in a network during real-time communication, i.e., adjusts the code rate and transmission position of protected data in real time according to network conditions, thereby effectively preventing voice discontinuousness, image mess or pause occurring at a client, and improving the user experience.

### Embodiment 2

The embodiment of the present disclosure further provides a system for anti-packet-loss real-time communication based on hierarchical coding. The system includes a transmitting end and a receiving end;

The transmitting end may be configured to set coding parameters and packaging parameters initially according to a network condition difference; generate a payload containing coded data and packaged data simultaneously according to the coding parameters and the packaging parameters and transmit the payload to the receiving end, and adjust the coding parameters and the packaging parameters in real time according to network status parameters transmitted by the receiving end, and generate a payload containing coded data and protected data simultaneously according to the adjusted coding parameters and the packaging parameters; and

the receiving end may be configured to receive the payload transmitted by the transmitting end, count the network status parameters according to the payload and transmit the network status parameters to the transmitting end; and determine whether a coded packet is lost according to the coded data transmitted by the transmitting end, and when determining that coded packet is lost, recover the lost coded packet according to the received payload.

### Embodiment 3

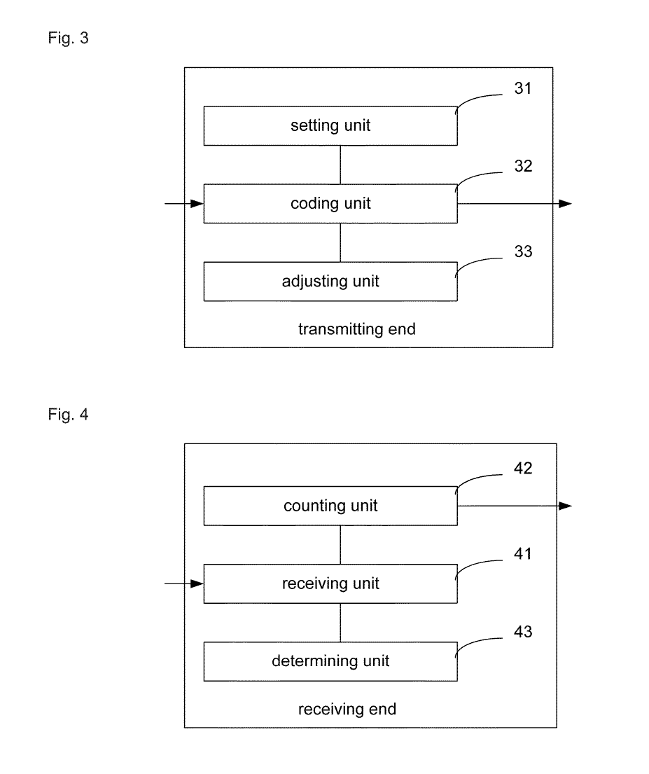

Referring to FIG. 3, the embodiment of the present disclosure provides a transmitting end, which includes a setting unit 31, a coding unit 31 and an adjusting unit 33; wherein,

the setting unit 31 may be configured to set coding parameters and packaging parameters initially according to a network condition difference and transmit the coding parameters and the packaging parameters to the coding unit 32;

the coding unit 32 may be configured to generate a payload containing coded data and protected data simultaneously according to the coding parameters and the packaging parameters transmitted by the setting unit 31 or the coding parameters and packaging parameters adjusted and transmitted by the adjusting unit and transmit the payload to a receiving end;

the adjusting unit 33 may be specifically configured to set a target code rate according to the network status parameters transmitted by the receiving end; when a packet loss rate is lower than or equal to a preset packet loss rate threshold, set a code rate of coded data only according to the target code rate without addition of protected data; when the packet loss rate is greater than the preset packet loss rate threshold, increase a code rate of the protected data within the limits of the target code rate, wherein the coding parameters may include the code rate of coded data and the packaging parameters may include the code rate of the protected data; capture part of or entire stream from the coded data corresponding to the transmission position of the protected data according to the adjusted packaging parameters and take the part of or entire stream as protected data; and when a continuous packet loss rate is lower than a preset continuous packet loss rate threshold, place the transmission position of the protected data in the next frame; and when the continuous packet loss rate is greater than the preset continuous packet loss rate threshold, place the transmission position of the protected data in the frame after the next frame.

### Embodiment 4

Referring to FIG. 4, the embodiment of the present disclosure provides a receiving end, which includes a receiving unit 41, a counting unit 42 and a determining unit 43; wherein,

the receiving unit 41 may be configured to receive a payload containing coded data and protected data transmitted by a transmitting end;

the counting unit 42 may be configured to count network status parameters according to the payload received by the receiving unit 41 and transmit the network status parameters to the transmitting end; and

the determining unit 43 may be configured to determine whether a coded packet is lost according to the payload received by the receiving unit 41, and when determining that the coded packet is lost, recover the lost coded packet according to the received payload.

In summary, the embodiments of the present disclosure provide an anti-packet-loss real-time communication method, system and related device based on hierarchical coding. A receiving end counts the current network status parameters in real-time and transmits the network status parameters to a transmitting end, the transmitting end adjusts coding parameters and packaging parameters in real time according to the current network status parameter, and assigns a code rate of coded data and a code rate of protected data in the packaged payload according to the coding parameters and the packaging parameters. The embodiments of the present disclosure perform self-adaptive processing on packet loss or congestion occurring in a network during real-time communication, i.e., adjust the code rate and transmission position of protected data in real time according to network conditions, thereby effectively preventing voice discontinuousness, image mess or pause occurring at a client, and improving the user experience.

The contents described above are only the preferred specific implementing modes of the present disclosure. However, the scope of the present disclosure is not limited thereto. Any changes or replacements in the technical scope of the present disclosure that can be easily thought of by those skills in the art should be covered with the protection scope of the present disclosure. Therefore, the protection scope of the the present disclosure should be subject to that of the claims.

### INDUSTRIAL APPLICABILITY

The embodiments of the present disclosure provide an anti-packet-loss real-time communication method, system and related device based on hierarchical coding. A receiving end counts the current network status parameters in real-time and transmits the network status parameters to a transmitting end, the transmitting end adjusts coding parameters and packaging parameters in real time according to the current network status parameter, and assigns a code rate of coded data and a code rate of protected data in the packaged payload according to the coding parameters and the packaging parameters. The embodiments of the present disclosure perform self-adaptive processing on packet loss or congestion occurring in a network during real-time communication, i.e., adjust the code rate and transmission position of protected data in real time according to network conditions, thereby effectively preventing voice discontinuousness, image mess or pause occurring at a client, and improving the user experience.

1. A method for anti-packet-loss real-time communication based on hierarchical coding, comprising:
generating, by a transmitting end, a payload containing coded data and protected data simultaneously according to coding parameters and packaging parameters which have been set, and transmitting the payload to a receiving end;
counting, by the receiving end, network status parameters according to the received payload and transmitting the network status parameters to the transmitting end; and
adjusting, by the transmitting end, the coding parameters and the packaging parameters in real time according to the network status parameters, and generating a payload containing coded data and protected data simultaneously according to the adjusted coding parameters and packaging parameters.

2. The method according to claim 1, further comprising:
determining, by the transmitting end, whether a coded packet is lost according to the received payload;
when determining that the coded packet is lost, finding protected data corresponding to the lost coded packet according to indication information in the received payload, and recovering the lost coded packet.

3. The method according to claim 1, wherein the network status parameters comprises one or more of a packet loss rate, a continuous packet loss rate, delay, jitter or a target code rate.

4. The method according to claim 3, wherein the adjusting, by the transmitting end, the coding parameters and the packaging parameters in real time according to the network status parameters comprises:
setting, by the transmitting end, the target code rate according to the network status parameters and adjusting the coding parameters and the packaging parameters in real time according to the target code rate and the packet loss rate.

5. The method according to claim 4, wherein the adjusting the coding parameters and the packaging parameters in real time according to the target code rate and the packet loss rate comprises:
when the packet loss rate is lower than or equal to a preset packet loss rate threshold, setting a code rate of the coded data only according to the target code rate without addition of protected data; when the packet loss rate is greater than the preset packet loss rate threshold, increasing a code rate of the protected data within limits of the target code rate, wherein the coding parameters comprise the code rate of the coded data and the packaging parameters comprise the code rate of the protected data.

6. The method according to claim 5, further comprising:
capturing part of or entire stream from coded data corresponding to a transmission position of the protected data according to the adjusted packaging parameters and taking the part of or entire stream as protected data;
when the continuous packet loss rate is lower than a preset continuous packet loss rate threshold, placing the transmission position of the protected data in a next frame; and when the continuous packet loss rate is greater than the preset continuous packet loss rate threshold, placing the transmission position of the protected data in a frame after the next frame, while adding indication information about the transmission position into the payload.

7. A system for anti-packet-loss real-time communication based on hierarchical coding, comprising a transmitting end and a receiving end; wherein,
the transmitting end is configured to generate a payload containing coded data and packaged data simultaneously according to coding parameters and packaging parameters which have been set and transmit the payload to the receiving end; and adjust the coding parameters and the packaging parameters in real time according to network status parameters transmitted by the receiving end, and generate a payload containing coded data and protected data simultaneously according to the adjusted coding parameters and packaging parameters; and
the receiving end is configured to receive the payload transmitted by the transmitting end, count the network status parameters according to the payload and transmit the network status parameters to the transmitting end.

8. The system according to claim 7, wherein,
the receiving end is further configured to determine whether a coded packet is lost according to the payload transmitted by the transmitting end, and when determining that the coded packet is lost, find protected data corresponding to the lost coded packet according to indication information in the payload, and recover the lost coded packet.

9. A transmitting end, comprising:
a setting unit configured to set coding parameters and packaging parameters and transmit the coding parameters and the packaging parameters to a coding unit;
the coding unit is configured to generate a payload containing coded data and protected data simultaneously according to the coding parameters and the packaging parameters transmitted by the setting unit or the coding parameters and packaging parameters adjusted and transmitted by a adjusting unit, and transmit the payload to a receiving end; and
the adjusting unit is configured to adjust the coding parameters and the packaging parameters in real time according to network status parameters transmitted by the receiving end, and transmit the adjusted coding parameters and packaging parameters to the coding unit.

10. The transmitting end according to claim 9, wherein,
the adjusting unit is configured to set a target code rate according to the network status parameters transmitted by the receiving end; when a packet loss rate is lower than or equal to a preset packet loss rate threshold, set a code rate of the coded data only according to the target code rate without addition of protected data; when the packet loss rate is greater than the preset packet loss rate threshold, increase a code rate of the protected data within limits of the target code rate, wherein the coding parameters comprise the code rate of coded data and the packaging parameters comprise the code rate of the protected data; further configured to capture part of or entire stream from coded data corresponding to a transmission position of the protected data according to the adjusted packaging parameters and take the part of or entire stream as protected data; when a continuous packet loss rate is lower than a preset continuous packet loss rate threshold, place the transmission position of the protected data in a next frame; and when the continuous packet loss rate is greater than the preset continuous packet loss rate threshold, place the transmission position of the protected data in a frame after the next frame.

11. A receiving end, comprising:
a receiving unit configured to receive a payload containing coded data and protected data transmitted by a transmitting end; and
a counting unit configured to count network status parameters according to the payload received by the receiving unit and transmit the network status parameters to the transmitting end.

12. The receiving end according to claim 11, further comprising:
a determining unit configured to determine whether a coded packet is lost according to the payload received by the receiving unit, and when determining that the coded packet is lost, find protected data corresponding to the lost coded packet according to indication information in the received payload, and recover the lost coded packet.

13. The method according to claim 2, wherein the network status parameters comprises one or more of a packet loss rate, a continuous packet loss rate, delay, jitter or a target code rate.

14. The method according to claim 13, wherein the adjusting, by the transmitting end, the coding parameters and the packaging parameters in real time according to the network status parameters comprises:
setting, by the transmitting end, the target code rate according to the network status parameters and adjusting the coding parameters and the packaging parameters in real time according to the target code rate and the packet loss rate.

15. The method according to claim 14, wherein the adjusting the coding parameters and the packaging parameters in real time according to the target code rate and the packet loss rate comprises:
when the packet loss rate is lower than or equal to a preset packet loss rate threshold, setting a code rate of the coded data only according to the target code rate without addition of protected data; when the packet loss rate is greater than the preset packet loss rate threshold, increasing a code rate of the protected data within limits of the target code rate, wherein the coding parameters comprise the code rate of the coded data and the packaging parameters comprise the code rate of the protected data.

16. The method according to claim 15, further comprising:
capturing part of or entire stream from coded data corresponding to a transmission position of the protected data according to the adjusted packaging parameters and taking the part of or entire stream as protected data;
when the continuous packet loss rate is lower than a preset continuous packet loss rate threshold, placing the transmission position of the protected data in a next frame; and when the continuous packet loss rate is greater than the preset continuous packet loss rate threshold, placing the transmission position of the protected data in a frame after the next frame, while adding indication information about the transmission position into the payload.
